(19) United States
(12) Patent Application Publication
(10) Pub. No.: US 2016/0053191 A1
(43) Pub. Date: Feb. 25, 2016

(54) METHOD OF EXTRACTING BIODIESEL CONVERTIBLE LIPID FROM MICROALGAE USING SUPERCRITICAL CARBON DIOXIDE

(71) Applicant: HANWOUL ENGINEERING INC., Gunpo-si (KR)

(72) Inventors: Hyun KWAK, Gunpo-si, (KR); Dong Jun PARK, Seoul (KR); Kyung Seok CHOI, Cheonan-si (KR); Jong Nam RAH, Gunpo-si (KR)

(73) Assignee: HANWOUL ENGINEERING INC., Gunpo-si (KR)

(21) Appl. No.: 14/719,907

(22) Filed: May 22, 2015

(30) Foreign Application Priority Data
Aug. 20, 2014 (KR) 10-2014-0108592

(51) Int. Cl. C10L 1/02; C11B 1/10

(52) U.S. Cl. CPC C10L 1/026; C11B 1/104; C10L 2200/0476; C10L 2270/026; C10L 2290/544

(57) ABSTRACT

Provided are a method of extracting a biodiesel convertible lipid from microalgae using a supercritical carbon dioxide and a biodiesel convertible lipid extracted by the method. The lipid extraction method is an economical and environmentally friendly technique, which may considerably reduce an extraction time, compared to a conventional supercritical carbon dioxide extraction method, does not use the toxic organic solvents used in the conventional Bligh-Dyer extraction method and Soxhlet extraction method, and exhibits an excellent lipid yield and a FAME yield.

### CROSS-REFERENCE TO RELATED APPLICATION

This application claims priority to and the benefit of Korean Patent Application No. 2014-0108592, filed on Aug. 20, 2014, the disclosure of which is incorporated herein by reference in its entirety.

### BACKGROUND

1. Field of the Invention

The present invention relates to a method of extracting a biodiesel convertible lipid from microalgae using a supercritical carbon dioxide, and a biodiesel convertible lipid extracted by the method.

2. Discussion of Related Art

Most types of energy used in the world are fossil fuels (petroleum, coal, natural gas, etc.). However, depletion of fossil fuels and serious environmental problems of climatic changes due to green house gas emission have become an issue, as well as recent sharp rises in crude oil prices, and thus it is necessary to develop new renewable energy which can replace fossil fuels^{[1,2]}.

Microalgae are unicellular photosynthetic microorganisms synthesizing organic materials using carbon dioxide (CO₂) included in the air or water and water as raw materials and light energy, and recovers carbon dioxide in the air due to high photosynthesis efficiency and generates characteristic materials through biochemical synthesis in cells. Particularly, microalgae have at least 10 times the lipid productivity of food crops due to their high lipid content^{[3-6]}. The most controversial issue of the first generation biofuel is a crop price rise caused by the use of farmland. Contrarily, microalgae are an inedible source and capable of being cultured not only in farmland but in any place with water and sunlight, and thus has attracted great attentions as a source for a next generation biofuel^{[7,8]}.

Biodiesel is an alternative fuel which can be directly used without modification of a conventional diesel engine, and a next generation biofuel produced through transesterification of a type of lipid, triglyceride, and alcohol. A biodiesel convertible lipid is included in a cell wall of microalgae, and depending on a type of algae, there are various contents and types of the lipid. As a general method for extracting the lipid from the microalgae, a Soxhlet extraction method and a Bligh & Dyer extraction method are used^{[9-11]}. when an organic solvent which is useful in extracting oil from a solid biomass, but usually has low selectivity to a neutral fat, that is, triglyceride, and high toxicity, like chloroform, is used, the organic solvent remains in an extracted lipid. An applicable lipid extracted from the microalgae can be applied to an extract such as a dietary supplement, for example, an antioxidant, a natural dye, DHA or EPA, as well as biofuel, and to produce such a high value extract, an extraction process not leaving an organic solvent is needed^{[12,13]}.

A supercritical fluid is defined as a material having a pressure and a temperature higher than a critical pressure and a critical temperature, and has a unique characteristic different from that of a common liquid or gas. Generally, solubility, which is capability of dissolving a material, is proportional to a density of the solvent, and the supercritical fluid has considerable solubility when a pressure is sufficiently high. However, a distance between molecules in a supercritical state is not as short as in a liquid, and values of viscosity, diffusion efficiency, thermal conductivity and surface tension are similar to those of a gas. That is, the supercritical fluid has fast permeability into a microspace due to high solubility, a high diffusion rate, and low surface tension. In addition, when a gas-type material is selected as a supercritical fluid at room temperature, a problem of a remaining solvent may be solved, and since a non-toxic and environmentally friendly process can be developed using a solvent which is not harmful for a human and less polluted, for example, carbon dioxide, the process is generally applied in high purity extraction of medicines, natural materials, food materials or cosmetic materials requiring safety^{[14-17]}.

While, due to the above-described advantages of the supercritical fluid, studies of extracting a lipid from microalgae using a supercritical carbon dioxide have been performed by some foreign researches^{[12-17]}, studies on the use of a co-solvent to extract a biodiesel convertible lipid and the characteristic of the extracted lipid have not been reported yet.

### PRIOR ART DOCUMENTS

### Patent Documents

(Patent Document 1) KR10-2003-0079276 A
(Patent Document 2) KR10-2011-0002738 A
(Patent Document 3) KR10-2011-0122640 A
(Patent Document 4) KR10-1227303 B
(Patent Document 5) KR10-0983023 B

### Non-Patent Documents

(Non-patent Document 1) 1. Demirbas, A., “Progress and Recent Trends in Biodiesel Fuels”, Energy Conversion and Management, 50, 14-34(2009)
(Non-patent Document 2) 2. Gavrilescu, M. and Chisti, Y., “Biotechnology—a Sustainable Alternative for Chemical Industry”, Biotechnology Advances, 23, 471-499(2005)
(Non-patent Document 3) 3. Pulz, O. and Gross, W., “Valuable products from biotechnology of microalgae”, Applied Microbiology and Biotechnology, 65, 635-648(2004)
(Non-patent Document 4) 4. Chisti, Y, “Biodiesel from Microalgae”, Biotechnology Advances, 25, 294-306(2007)
(Non-patent Document 5) 5. Rosenberg, J. N., Oyler, G A., Wilkinson, L. and Betenbaugh, M. J., “A Green Light for Engineered Algae: Redirecting Metabolism to Fuel a Biotechnology Revolution”, Current Opinion in Biotechnology, 19, 430-436(2008)
(Non-patent Document 6) 6. Schenk, P. M., Thomas-Hall, S. R., Stephens, E., Marx, U. C., Mussgnug, J. H., Posten, C., Kruse, O. and Hankamer, B., “Second Generation Biofuels: High-Efficiency Microalgae for Biodiesel Production”, Bioenergy Research, 1, 20-43(2008)
(Non-patent Document 7) 7. Lardon, L., Helias, A., Sialve, B., Steyer, P. and Bernard, O., “Life-Cycle Assessment of Biodiesel Production from Microalgae”, Environmental Science & Technology, 43(17), 6475-6481(2009)
(Non-patent Document 8) 8. Mata, T. M., Martins A. A. and Caetano, N. S., “Microalgae for Biodiesel Production and Other Applications: A Review”, Renewable and Sustainable Energy Reviews, 14, 217-232(2010)
(Non-patent Document 9) 9. Mercer, P. and Amenta, R. E., “Developments in Oil Extraction from Microalgae”, European Journal of Lipid Science and Technology, 113, 539-547(2011)
(Non-patent Document 10) 10. Araujo, G S., Matos, L. J. B. L., Fernandes, J. O., Cartaxo, S., J. M., Goncalves, L. R. B., Fermamdes, F A. N. and Farias, W. R. L., “Extraction of Lipids from Microalgae by Ultrasound Application: Prospection of the Optimal Extraction Method”, Ultrasonics Sonochemistry, 20, 95-98(2013)
(Non-patent Document 11) 11. Shin, H. Y., Ryu, J. H., Bae, S. Y., Crofcheck, C. and Crocker, M., “Lipid Extraction from Scenedesmus sp. Microalgae for Biodiesel Production Using Hot Compressed Hexane”, Fuel, 130, 66-69(2014)
(Non-patent Document 12) 12. Taher, H., Al-Zuhair, S., Al-Marzouqi, A. H., Haik, Y., Farid, M. and Tariq, S., “Supercritical Carbon Dioxide Extraction of Microalgae Lipid: Process Optimization and Laboratory Scale-Up”, Journal of Supercritical Fluids, 86, 57-66(2014)
(Non-patent Document 13) 13. Tang, S., Qin, C., Wang, H., Li, S. and Tian, S., “Study on Supercritical Extraction of Lipids and Enrichment of DHA from Oil-Rich Microalgae”, Journal of Supercritical Fluids, 57, 44-49(2011)
(Non-patent Document 14) 14. Mendes, R. L., Nobre, B. P., Cardoso, M. T., Pereira, A. P. and Palavra, A. E, “Supercritical Carbon Dioxide Extraction of Compounds with Pharmaceutical Importance from Microalgae”, Inorganica Chimica Acta, 356, 328-334(2003)
(Non-patent Document 15) 15. Cheung, P. C. K., “Temperature and Pressure Effects on Supercritical Carbon Dioxide Extraction of n-3 Fatty Acids from Red Seaweed”, Food Chemistry, 65, 399-403(1999)
(Non-patent Document 16) 16. Andrich, G, Nesti, U., Venturi, F, Zinnai, A. and Fiorentini, R., “Supercritical Fluid Extraction of Bioactive Lipids from the Micrialga Nannochloropsis sp.”, European Journal of Lipid Science and Technology, 107, 381-386(2005)
(Non-patent Document 17) 17. Couto, R. M., Simoes, P. C., Reis, A., Silva, T. L. D., Martins, V. H. and Sanchex-Vicente, Y, “Supercritical Fluid Extraction of Lipids from the Heterotrophic Microalga Crypthecodinium Cohnii”, Engineering in Life Sciences, 10(2), 158-164(2010)
(Non-patent Document 18) 18. Kinney, A. J. and Clemente, T. E., “Modifying Soybean Oil for Enhanced Performance in Biodiesel Blends”, Fuel Processing Technology, 86, 1137-1147(2005)

### SUMMARY OF THE INVENTION

The present invention is directed to providing a new lipid extraction method which is improved in a lipid yield, a fatty acid methyl ester yield and reduction of an extraction process, compared to a conventional method of extracting a lipid from microalgae using a supercritical carbon dioxide, and a biodiesel convertible lipid extracted by the method.

In one aspect, the present invention provides a method of extracting a biodiesel convertible lipid from microalgae by a supercritical carbon dioxide extraction method using a supercritical carbon dioxide and methanol as a co-solvent.

In the extraction method, an extraction temperature may be 35 to 65° C.

In the extraction method, an extraction pressure may be 250 to 350 bar.

In the extraction method, an extraction time may be 30 to 60 minutes.

The methanol may be injected at 5 to 15 vol % of an injection ratio of the supercritical carbon dioxide.

The microalgae may be selected from the group consisting of Nannochloropsis sp., Chlorella sp. and Scenedesmus sp.

The extraction method may include extracting the biodiesel convertible lipid from Nannochloropsis sp. microalgae at a temperature of 50° C. and a pressure of 300 bar for 30 minutes, and the injection ratio of the supercritical carbon dioxide and methanol as a co-solvent may be 1:0.1.

In another aspect, the present invention provides a biodiesel convertible lipid using the method of extracting a lipid of the present invention.

### BRIEF DESCRIPTION OF THE DRAWINGS

The above and other objects, features, and advantages of the present invention will become more apparent to those of ordinary skill in the art by describing exemplary embodiments thereof in detail with reference to the accompanying drawings, in which:

FIG. 1 is a schematic diagram of an apparatus used in a supercritical carbon dioxide extraction method of the present invention; and

FIG. 2 shows a gas chromatography (GC) result to confirm lipid components extracted from Nannochloropsis sp. microalgae by a supercritical carbon dioxide extraction method using methanol as a co-solvent according to the present invention.

### DETAILED DESCRIPTION OF EXEMPLARY EMBODIMENTS

Hereinafter, the present invention will be described in detail.

The inventors of the present invention extracted a biodiesel convertible lipid from Nannochloropsis sp. microalgae using a supercritical carbon dioxide extraction method. To evaluate efficiency according to the extraction method, yields of an extracted crude lipid and fatty acid methyl ester (FAME) were measured, and the results were compared with a lipid extracted by an organic solvent extraction method such as a Soxhlet method using hexane as a solvent and a Bligh-Dyer extraction method using chloroform, methanol or distilled water as a solvent. To change polarity of a process of extracting supercritical carbon dioxide and increase extraction efficiency, methanol was used as a co-solvent, and feasibility as a method of extracting biodiesel-producible lipid was evaluated.

In one aspect of the present invention, the present invention provides a method of extracting a biodiesel convertible lipid from microalgae. The extraction method according to an exemplary embodiment of the present invention is an extraction method including putting dried microalgae powder into a tube-type extractor, injecting a supercritical carbon dioxide and methanol together, and comparing yields by extracting a lipid by a Bligh-Dyer extraction method including stirring at room temperature and an atmospheric pressure using chloroform, methanol and distilled water, and a Soxhlet extraction method using normal hexane through solvent circulation for 428 cycles at 80° C. for 24 hours to prove extraction efficiency.

According to an exemplary embodiment of the present invention, as a raw material for extracting a biodiesel convertible lipid, dried powder-type microalgae are used. Microalgae lipids are largely divided into neutral fats and polar fats, and included in a cell wall together with cytoplasm. To extract the neutral fat, a non-polar organic solvent is used, and an extraction mechanism of the neutral fat is as follows: when microalgae are sufficiently dissolved in an organic solvent, (1) causing a non-polar solvent such as chloroform or normal hexane to permeate a cell wall of the microalgae and containing cytoplasm; (2) dissolving a neutral fat in a solvent by a Van der Waals force; (3) diffusing a solvent-lipid material out of the cell wall; and (4) extracting the lipid using a non-polar solvent around the microalgae. Accordingly, to extract the neutral lipid from the microalgae, it is necessary to use a non-polar solvent.

However, some neutral fats contained in the cytoplasm form strong hydrogen bonds with a protein attached to the cell wall. That is, a polar-non-polar lipid complex is attached to the cell wall, and to extract the lipid complex, it is necessary to use a polar solvent capable of breaking the strong hydrogen bond between the lipid and the protein to extract the fat. As a representative polar solvent used herein, methanol or propanol is used, and an extraction mechanism using this solvent is as follows: (1) passing a polar-non-polar solvent through the cell wall to allow the solvent to contain cytoplasm; (2) binding the non-polar solvent to the lipid-protein complex by a Van der Waals force to allow the solvent to contain the neutral fat in the lipid-protein complex; (3) binding the polar solvent to the lipid-protein complex by a hydrogen bond to isolate the lipid from the cell wall and allow the solvent to contain a polar lipid; and (4) extracting the mixed lipid by passing the polar-non-polar solvent containing the mixed lipid through the cell wall. Accordingly, to efficiently extract the lipid from the microalgae, a polar-non-polar solvent mixed solution should be used.

In another aspect of the present invention, to evaluate suitability as a lipid-type biodiesel extracted from microalgae, the lipids extracted by the three extraction methods are converted into fatty acid methyl ester, and the content and fatty acid composition thereof were identified. As the result, it is evaluated that the extraction method according to the present invention, that is, the injection of a supercritical carbon dioxide and methanol together is effective and economical to extract a biodiesel convertible lipid.

In the present invention, a method of evaluating suitability as a biodiesel is a method of identifying a FAME content and a composition of a fatty acid through esterification and transesterification of the extracted lipid using BF₃-methanol. The biodiesel consists of the FAME formed through transesterification of triglyceride and methanol at a content of 96.5% or more. In addition, depending on a type of oil used herein, the composition of the fatty acid of the biodiesel is changed and affects a characteristic of a fuel quality. For example, when the raw material contains a large quantity of unsaturated fatty acid, low oxidation stability is caused, and on the other hand, a saturated fatty acid has a bad influence on low temperature flowability. Therefore, the identification of the fatty acid composition of the raw material used herein is important information in conversion into biodiesel, which will be performed later. Accordingly, the evaluation of suitability as biodiesel of the lipid extracted from microalgae is necessary to identify the FAME content and the fatty acid composition thereof after conversion of FAME.

Accordingly, the present invention provides a method of extracting a biodiesel convertible lipid from microalgae by a supercritical carbon dioxide extraction method using a supercritical carbon dioxide and methanol as a co-solvent.

In the extraction method, an extraction temperature may be 35 to 65° C., an extraction pressure may be 250 to 350 bar, and an extraction time may be 30 to 60 minutes. In addition, the methanol may be used at 5 to 15 vol % of an injection ratio of the supercritical carbon dioxide.

The microalgae may be selected from the group consisting of Nannochloropsis sp., Chlorella sp. and Scenedesmus sp.

According to an exemplary embodiment, the extraction method may include extracting the lipid from Nannochloropsis sp. microalgae at a temperature of 50° C. and a pressure of 300 bar for 30 minutes, and the injection ratio of the supercritical carbon dioxide and methanol as a co-solvent may be controlled to a flow rate of 1:0.1.

The present invention provides a biodiesel convertible lipid by the above-described extraction method.

Hereinafter, the present invention will be described in further detail with reference to specific examples.

### EXAMPLES

### Experimental Example 1

### 1. Method

### 1-1. Sample

Microalgae used herein were powder-type Nannochloropsis sp. (PROVIRON INDUSTRIES NV, Provifeed™ Nannochloropsis FD, Belgium) obtained by centrifuging and lyophilizing a culture solution cultured in a photobioreactor, and the lyophilized sample was sealed and stored in a refrigerator at 4° C. before the experiment. Components of Nannochloropsis sp. purchased from PROVIRON are shown in Table 1.

TABLE 1

| Component | Content (wt. %) | Test method |
|---|---|---|
| Total neutral fat | 15-25 | ISO 1443 |
| Protein | 35-45 | ISO 937-ISO 1871 |
| Ash | max. 20 | ISO 936 |
| Water | max. 10 | — |

### 1-2. Bligh-Dyer Extraction Method

5 g of Nannochloropsis-dried powder was quantified and put into a flask, and 50 ml of chloroform, 50 ml of methanol and 45 ml of distilled water were added (1:1:0.9, v/v/v), and then stirred at 150 rpm for 2 hours. The stirred sample passed through a glass microfiber filter (Whatman™, 0.45 nm, UK) to separate a solid phase and a liquid phase, and then put into a separating funnel for 10 minutes to separate water from the extracted liquid phase product. A solvent was evaporated from the chloroform layer containing a fat isolated from the generated isolation layer using a rotary evaporator (EYELA, N-1110V, Japan), a yield was measured, and a FAME content of a lipid component was analyzed.

### 1-3. Soxhlet Extraction Method

5 g of Nannochloropsis-dried powder was quantified and put into a thimble filter (ADVANTEC, ID25mm OD28mm L100mm, Japan), the filter was installed in a Soxhlet extractor, and then extraction was performed for 24 hours using 300 ml n-hexane (solvent circulation cycle: 428 cycles). The solvent was evaluated after the extraction was terminated, and an extracted lipid was quantified.

### 1-4. Supercritical Carbon Dioxide Extraction Method

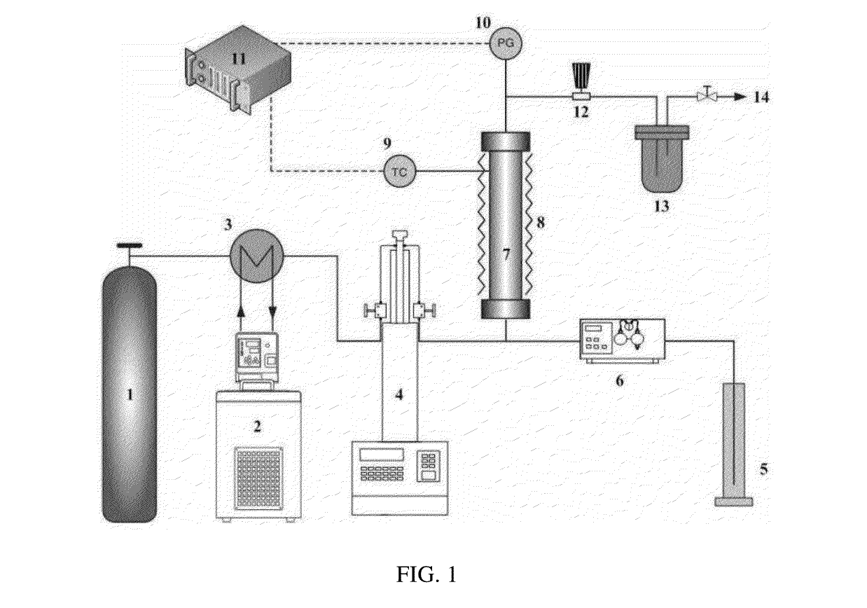

A schematic diagram of a reaction device used in an experiment of extracting a supercritical carbon dioxide is shown in FIG. 1. The reactor used herein was a tube-type reactor formed of sus316 material and having an inner capacity of 20 ml (1.5 cm I.D., 12 cm Height). 5 g of Nannochloropsis-dried powder was quantified and put into a reactor, and both ends of the reactor were blocked with glass wool to prevent emission of the sample out of the reactor in CO₂ extraction. To liquefy CO₂, a liquefaction condenser was maintained at −10° C., and a syringe pump (ISCO, 260D, U.S.A.) was used to press CO₂ to a desired extraction pressure. After reaching a desired pressure, an inner pressure of the reactor was uniformly maintained (400 bar) using a back pressure regulator (TESCOM, 26-1762-24-161, U.S.A.), and a content of the liquefied CO₂ was uniformly maintained at 4 ml/min A temperature of the reactor was controlled (to 50° C.) by winding a heating band and connecting the reactor to a PID controller. To examine a co-solvent effect, a co-solvent, methanol, was uniformly injected into the reactor at a flow rate of 0.4 ml/min using an HPLC pump (Chrom Tech, Inc., P-1010, U.S.A.) at the same time as CO₂ injection. A reaction was performed for 30 minutes, and an extract extracted from the supercritical carbon dioxide was a liquid-phase product isolated from gas-type CO₂ from a separator. A yield of the extract was measured by evaporating methanol through a rotary evaporator, and a FAME content was analyzed.

### 1-5. Fatty Acid Analysis

To analyze the FAME content and the composition of the fatty acid of the extracted lipid, 4 ml of BF₃/methanol was put into 400 mg of the extracted lipid and transesterification was performed at 80° C. for 2 hours. A reaction solution was cooled to a room temperature, 5 ml of hexane and 2 ml of distilled water were added and separated into an organic phase and an aqueous phase using a centrifugal separator. The organic phase, which was a supernatant, was taken and put into a rotary evaporator to remove the solvent, and 3 ml of an internal standard was added to 75 mg of the reaction product, and analyzed using GC (Agilent, HP-6890, U.S.A.) equipped with a flame ionization detector (FID). As the internal standard, 5 mg/ml of a solution prepared by methyl heptadecanoate in hexane was used, and an HP-88 capillary column (Agilent, 100 m×0.25 mm×0.2 μm, U.S.A.) was used as a GC column Analysis was performed by injecting 1 μl of the sample at an initial column temperature of 50° C., and a temperature was increased to 170° C. at 10° C./min and 170 to 210° C. at 5° C./min, maintained for 10 minutes, increased to 230° C. at 5° C./min, and then maintained for 6 minutes. Here, a flow rate of a carrier gas (He) was 1 ml/min, and temperatures of an injector and a detector were maintained at 260° C. To identify components of the FAME, GC/MS (Agilent, HP-5973, USA) was used. A temperature of an ion source was maintained at 280° C., and a temperature of the interface was maintained at 260° C. Qualification analysis was performed by comparing retention time of peaks of a measured sample and a standard sample, and confirmed using an EI mass spectra (70 eV, 50˜500 m/z).

### 2. Result

A supercritical carbon dioxide extraction method (50° C., 400 bar), supercritical extraction using methanol as a co-solvent, a Bligh-Dyer extraction method and a Soxhlet extraction method were performed on Nannochloropsis sp. microalgae containing 15 to 25% of total neutral fat, and results were compared. In the supercritical carbon dioxide extraction, to change polarity, generally methanol, ethanol, toluene, or a mixed solution of methanol-water was used. In the present invention, to increase extraction efficiency, methanol having a high polarity and high efficiency in extracting an unsaturated fatty acid was selected and used. Yields of all of crude lipids obtained by the extraction were calculated as follows:

$$Lipid Yield ( wt . \% ) = \frac{weight of extracted lipid ( g )}{weight of microalgae ( g )} \times 100 \qquad ( 1 )$$

Averages and standard deviations of the crude lipid yields extracted by respective extraction methods are shown in Table 2.

TABLE 2

| Extraction method | Yield^{a} (wt. %) | Extraction time (hour) |
|---|---|---|
| Bligh-Dyer | 18.0 (±0.8) | 2 |
| Soxhlet | 8.8 (±0.4) | 24 |
| SC-CO₂^{b} | 6.9 (±0.6) | 1 |
| SC-CO₂ w/co-solvent^{c} | 12.5 (±0.6) | 0.5 |

^{a}Lipid yields represent the average of three experiment (±standard deviation).
^{b}SC-CO₂ extraction was performed at 50° C., 400 bar, and 4.0 mL/min CO₂.
^{c}SC-CO₂ w/co-solvent was performed at 50° C., 400 bar, 4.0 mL/min CO₂, and 0.4 mL MeOH.

The Bligh-Dyer extraction method showed a relatively high yield of 18.0 wt %, and the Soxhlet extraction method showed a lipid yield of 8.8 wt %, even though the extraction was performed for 24 hours. While, according to the supercritical carbon dioxide extraction method, a lipid yield was 6.9 wt %, when methanol was added as a co-solvent, even though the extraction time was reduced to 30 minutes, a relatively high yield of 12.5 wt % was obtained. The lipids were an organic compound which is not easily dissolved in water, and most of the lipids can be classified into two types such as neutral lipids (acylglycerols, free fatty acids (FFA), hydrocarbons, sterols, ketones, and pigments) and polar lipids (phospholipids and glycolipids) according to a molecular structure. The Bligh-Dyer extraction method obtained the highest lipid extract yield because it can extract all of neutral lipids and polar lipids in the microalgae using a non-polar solvent such as chloroform and polar solvents such as methanol and distilled water. The yields of the lipids extracted by the Soxhlet and SC—CO₂ extraction methods had a somewhat small difference of 1.9 wt. % despite a considerably large difference in extraction time. This is because a cell wall breaking effect caused by a supercritical high pressure fluid. However, it was seen that the yields of the lipids extracted by the Soxhlet and SC—CO₂ extraction methods using a non-polar solvent were relatively low. When methanol was added as a co-solvent at the same time as the extraction of supercritical carbon dioxide, a yield of a total extracted crude lipid was relatively high of 12.5 wt %. This is because, as the methanol added as a co-solvent increases polarity of the supercritical carbon dioxide, the methanol is rapidly caused to permeate into a cell wall of the microalgae and an affinity of a fluid to the polar lipid is increased.

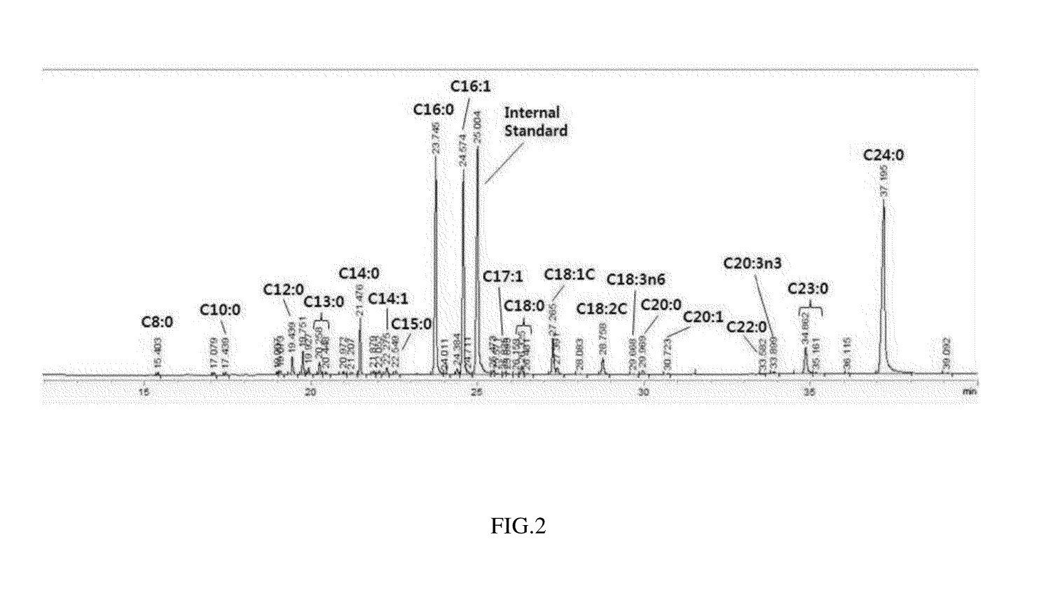

Contents of acylglycerols, FFA and fatty acid which are convertible to a main component of biodiesel, FAME, of the extracted crude lipid were important. Accordingly, the lipid extracted by each extraction method was transesterificated, and then the FAME content was calculated by GC analysis. In FIG. 2, a GC chromatogram of the lipid extracted using a supercritical carbon dioxide and methanol as a co-solvent was representatively shown. A FAME composition according to each extraction method was analyzed, and a FAME content (%) and a FAME yield (wt %) were calculated and shown in Table 3. The FAME content and the FAME yield were calculated by the following equation.

$$\begin{matrix}F A M E content ( \% ) = \frac{( \sum A ) - {A}_{ISTD}}{{Λ}_{ISTD}} \times \frac{{C}_{ISTD} \times {V}_{ISTD}}{m} \times 100 \\ \sum A is the total peak area from F A M E \\ {Λ}_{ISTD} is the peak area corresponding to methyl heptadecanoate {C}_{ISTD} is the concentration of the methyl heptadecanoate solution [ mg \text{/} ml ] \\ {V}_{ISTD} is the volume of the methyl heptadecanoate solution [ ml ] m is the mass of the sample [ mg ] & ( 2 ) \\ F A M E yield ( wt . \% ) = \frac{Lipid yield ( wt . \% ) \times F A M E content ( \% )}{100} & ( 3 )\end{matrix}$$

TABLE 3

| | Extraction method | | | |
|---|---|---|---|---|
| | Bligh-Dyer | Soxhlet | SC-CO₂ | SC-CO₂ w/MeOH |
| Extraction time (hr) | 2 | 24 | 1 | 0.5 |
| Crude lipid yield (wt %) | 18.0 (−0.8) | 8.8 (+0.8) | 6.9 (+0.6) | 12.5 (−0.6) |
| FAME composition (% FAME) | | | | |
| Butyric acid (C4:0) | 0.00 | 0.21 | 0.00 | 0.00 |
| Caprylic acid (C8:0) | 0.00 | 0.21 | 0.00 | 0.18 |
| Decanoic acid (C10:0) | 0.00 | 0.33 | 0.23 | 0.24 |
| Lauric acid (C12:0) | 0.71 | 1.34 | 0.63 | 1.53 |
| Tridecanoic acid (C13:0) | 0.31 | 1.32 | 0.19 | 1.49 |
| Myristic acid (C14:0) | 4.11 | 4.93 | 3.92 | 4.15 |
| Myristoleic acid (C14:1) | 0.36 | 0.70 | 0.10 | 0.74 |
| Pentadecanoic acid (C15:0) | 0.27 | 0.35 | 0.31 | 0.33 |
| Palmitic acid (C16:0) | 22.93 | 29.03 | 27.29 | 23.01 |
| Palmitoleic acid (C16:1) | 21.08 | 24.79 | 26.56 | 21.05 |
| Heptadenoic acid (C17:1) | 0.27 | 0.20 | 0.25 | 0.23 |
| Stearic acid (C18:0) | 0.51 | 1.26 | 1.83 | 1.10 |
| Oleic acid (C18:1c) | 4.40 | 5.89 | 10.60 | 4.80 |
| Lonolelaidic acid (C18.2t) | 0.15 | 0.00 | 0.37 | 0.00 |
| Linoleic acid (C18:2c) | 2.20 | 1.57 | 8.78 | 1.98 |
| γ-Linolenic acid (C18:3n6) | 0.00 | 0.23 | 0.29 | 0.13 |
| Arachidic acid (C20:0) | 0.58 | 0.46 | 0.45 | 0.53 |
| Eicosenoic acid (C20:1) | 0.00 | 0.00 | 0.22 | 0.13 |
| Eicosadienoic acid (C20:2) | 0.00 | 0.19 | 0.11 | 0.00 |
| Behenic acid (C22:0) | 0.16 | 0.00 | 0.41 | 0.13 |
| Eicosapentaenoic acid (C20:3n3) | 0.42 | 0.34 | 0.36 | 0.33 |
| Erucic acid (C22:1) | 0.00 | 0.30 | 0.16 | 0.00 |
| Tricosanoic acid (C23:0) | 5.24 | 3.05 | 2.39 | 4.23 |
| Eicosapentaenoic acid (C20:5) | 36.31 | 23.31 | 14.43 | 33.70 |
| Docosahexaenoic acid (C22:6) | 0.00 | 0.00 | 0.11 | 0.00 |
| Degree of unsaturation^{a} | 213.63 | 153.67 | 131.17 | 200.78 |
| FAME content (%) | 53.69 | 53.06 | 58.31 | 56.32 |
| FAME yield (wt %) | 9.66 | 4.67 | 4.02 | 7.04 |

^{a}Degree of unsaturation - 1 × monoene (%) + 2 × diene (%) − 3 × triene (%) + 4 × tetraene (%) + 5 × pentaene (%) − 6 × hexaene (%)

Referring to Table 3, according to the analysis results for the lipids extracted by various methods, it was seen that the influence on the FAME composition was insignificant. The main FAME of the extracted lipid was methyl ester of palmitic acid (C16:0), palmitoleic acid (C16:1), oleic acid (C18:1c), tricosanoic acid (C20:5), or eicosapentaenoic acid (C20:5). The SC—CO₂ extraction method showed the smallest level in a degree of unsaturation, which was 131. 17, the Bligh-Dyer method showed the largest value in a degree of unsaturation, which was 213.63, and the SC—CO₂ w/MeOH extraction method had a degree of unsaturation of 200.78. It was reported by Kinney et al.^{[18]} that physicochemical properties of the biodiesel are changed according to the composition of fatty acid in a raw material and the composition of the methyl ester derived therefrom. For example, it has been reported that biodiesel generated from a raw material containing a large amount of saturated fatty acids such as palmitic acid or stearic acid had poor low temperature flowability, and biodiesel generated from an unsaturated fatty acid such as linoleic acid or linolenic acid had lower oxidation stability than a saturated fatty acid. Accordingly, it has been reported that the biodiesel generated by the SC—CO₂ extraction method has high oxidation stability, but biodiesel generated by the SC—CO₂ w/MeOH extraction method had a somewhat lower oxidation stability since containing a large amount of unsaturated fatty acids.

It was shown that FAME selectivity was relatively high in the supercritical extraction method, compared to a general organic solvent extraction method, and particularly, the highest selectivity, that is, 58.31%, was shown in the SC—CO2 extraction method among the four extraction methods. To use the lipid extracted from the microalgae as a raw material of biodiesel, a content of neutral fat should be high. It is considered that since supercritical carbon dioxide has a high extraction selectivity to non-polar neutral fat, the FAME content is high.

The FAME yield was the highest, that is, 9.66 wt %, in the Bligh-Dyer extraction method, 7.04 wt % in the SC—CO₂ extraction method using methanol as a co-solvent, and 4.67 and 4.02 wt % in the Soxhlet extraction method and the SC—CO₂ extraction method, respectively. When the Blight-Dyer method was used, the largest FAME yield was obtained, but an organic solvent having strong toxicity such as chloroform was used, and the extraction times was a little long. Accordingly, it is considered that the SC—CO₂ w/MeOH extraction method having the shortest extraction time of 30 minutes and a relatively high FAME yield of 7.04 wt % is an environmentally friendly and efficient extraction method to extract a biodiesel-producible lipid.

### Experimental Example 2

A lipid was extracted by the same method as described in Example 1, except that Nannochloropsis sp. microalgae (Yenta Hairong Biology Technology, China) were used and a pressure in an SC—CO₂ extraction method was controlled to 300 bar. The yield and FAME content of the extracted lipid are shown in Table 4.

TABLE 4

| | Bligh-Dyer | Soxhlet | SC-CO₂ w/co-sol. |
|---|---|---|---|
| lipid yield (%) | 21.1 | 12.2 | 12.3 |
| FAME content (%) | 71.75 | 68.05 | 72.75 |

### Experimental Example 3

A lipid was extracted by the same method as described in Example 1, except that Chlorella sp. microalgae (Yantai Hairong Biology Technology, China) were used. The yield and FAME content of the extracted lipid are shown in Table 5.

TABLE 5

| | Bligh-Dyer | Soxhlet | SC-CO₂ w/co-sol. |
|---|---|---|---|
| lipid yield (%) | 14.1 | 10.1 | 7.3 |
| FAME content (%) | 59.96 | 60.78 | 62.17 |

### Experimental Example 4

A lipid was extracted by the same method as described in Example 1, except that Scenedesmus sp. microalgae (USA) were used. The yield and FAME content of the extracted lipid are shown in Table 6.

TABLE 6

| | Bligh-Dyer | Soxhlet | SC-CO₂ w/co-sol. |
|---|---|---|---|
| lipid yield (%) | 15.2 | 11.8 | 7.8 |
| FAME content (%) | 61.80 | 64.86 | 67.75 |

### Experimental Example 5

Lipids were extracted according to the temperature, pressure, time, CO₂, MeOH, microalgae, and extraction methods shown in Table 7, and yields were confirmed.

| | | Temperature | Pressure | Time | | | | | | F/C | |
|---|---|---|---|---|---|---|---|---|---|---|---|
| | | (° C.) | (bar) | (hr) | CO2 (ml) | MeOH (ml) | Microalgea (5 g) | Test Method | L/Y (%) | (%) | F/Y (%) |
| Changes in | Example 1 | 50 | 300 | 30 | 4 | 0.4 | Nannochloropsis | SC—CO2/MeOH | 12.30 | 72.75 | 8.95 |
| Algae, | Example 2 | 50 | 300 | 30 | 4 | 0.4 | Chlorella | SC—CO2/MeOH | 7.30 | 62.17 | 4.54 |
| Method | Example 3 | 50 | 300 | 30 | 4 | 0.4 | Scenedesmus | SC—CO2/MeOH | 7.80 | 67.75 | 5.28 |
| | Comparative | AMB. | ATM. | 120 | 4 | 0.4 | Nannochloropsis | Bligh-Dyer | 21.10 | 71.75 | 15.14 |
| | Example 1 | | | | | | | | | | |
| | Comparative | AMB. | ATM. | 120 | 4 | 0.4 | Chlorella | Bligh-Dyer | 14.10 | 59.96 | 8.45 |
| | Example 2 | | | | | | | | | | |
| | Comparative | AMB. | ATM. | 120 | 4 | 0.4 | Scenedesmus | Bligh-Dyer | 15.20 | 61.8 | 9.39 |
| | Example 3 | | | | | | | | | | |
| | Comparative | AMB. | ATM. | 1440 | 4 | 0.4 | Nannochloropsis | Soxhlet | 12.20 | 68.05 | 8.30 |
| | Example 4 | | | | | | | | | | |
| | Comparative | AMB. | ATM. | 1440 | 4 | 0.4 | Chlorella | Soxhlet | 10.10 | 60.78 | 6.14 |
| | Example 5 | | | | | | | | | | |
| | Comparative | AMB. | ATM. | 1440 | 4 | 0.4 | Scenedesmus | Soxhlet | 11.80 | 64.86 | 7.65 |
| | Example 6 | | | | | | | | | | |
| Change | Example 4 | 50 | 250 | 60 | 4 | 0.4 | Nannochloropsis | SC—CO2/MeOH | 8.30 | | |
| in | Example 5 | 50 | 300 | 60 | 4 | 0.4 | Nannochloropsis | SC—CO2/MeOH | 12.30 | | |
| Pressure | Example 6 | 50 | 350 | 60 | 4 | 0.4 | Nannochloropsis | SC—CO2/MeOH | 10.80 | | |
| Change | Example 7 | 35 | 250 | 60 | 4 | 0.4 | Nannochloropsis | SC—CO2/MeOH | 6.60 | | |
| in | Example 8 | 50 | 250 | 60 | 4 | 0.4 | Nannochloropsis | SC—CO2/MeOH | 8.30 | | |
| Temperature | Example 9 | 65 | 250 | 60 | 4 | 0.4 | Nannochloropsis | SC—CO2/MeOH | 9.00 | | |
| Change | Example 10 | 50 | 300 | 30 | 4 | 0.4 | Nannochloropsis | SC—CO2/MeOH | 12.30 | | |
| in | Example 11 | 50 | 300 | 45 | 4 | 0.4 | Nannochloropsis | SC—CO2/MeOH | 12.40 | | |
| Time | Example 12 | 50 | 300 | 60 | 4 | 0.4 | Nannochloropsis | SC—CO2/MeOH | 12.70 | | |

The above-described Examples of the present invention are merely exemplary embodiments of the present invention, and the scope of the present invention is not limited to specific ranges of types of microalgae, reaction conditions, etc. described in the Examples.

A method of extracting a lipid of the present invention is an economical and environmentally friendly technique, which can considerably reduce an extraction time, compared to a conventional supercritical carbon dioxide extraction method, does not use the toxic organic solvents used in the conventional Bligh-Dyer extraction method and Soxhlet extraction method, and exhibits an excellent lipid yield and a FAME yield.

While the invention has been shown and described with reference to certain exemplary embodiments thereof, it will be understood by those skilled in the related art that various changes in form and details may be made therein without departing from the scope of the invention as defined by the appended claims.

What is claimed is:

1. A method of extracting a biodiesel convertible lipid from microalgae by a supercritical carbon dioxide extraction method using a supercritical carbon dioxide and methanol as a co-solvent.

2. The method according to claim 1, wherein the extraction method is performed at an extraction temperature of 35 to 65° C.

3. The method according to claim 1, wherein the extraction method is performed at an extraction pressure of 250 to 350 bar.

4. The method according to claim 1, wherein the extraction method is performed for an extraction time of 30 to 60 minutes.

5. The method according to claim 1, wherein the methanol is injected at 5 to 15 vol % of the injection ratio of the supercritical carbon dioxide.

6. The method according to claim 1, wherein the microalgae are selected from the group consisting of Nannochloropsis sp., Chlorella sp. and Scenedesmus sp.

7. The method according to claim 1, comprises:
extracting the biodiesel convertible lipid from Nannochloropsis sp. microalgae at a temperature of 50° C. and a pressure of 300 bar for 30 minutes,
wherein the injection ratio of the supercritical carbon dioxide to the co-solvent, methanol, is 1:0.1.

8. A biodiesel convertible lipid using the extraction method according to claim 1.

9. A biodiesel convertible lipid using the extraction method according to claim 2.

10. A biodiesel convertible lipid using the extraction method according to claim 3.

11. A biodiesel convertible lipid using the extraction method according to claim 4.

12. A biodiesel convertible lipid using the extraction method according to claim 5.

13. A biodiesel convertible lipid using the extraction method according to claim 6.

14. A biodiesel convertible lipid using the extraction method according to claim 7.
